(19) United States
(12) Patent Application Publication
(10) Pub. No.: US 2014/0127418 A1
(43) Pub. Date: May 8, 2014

(54) METHOD FOR PREPARING SURFACES

(71) Applicants: Christophe Navarro, Bayonne (FR); Stéphane Magnet, Morlanne (FR); Xavier Chevalier, Grenoble (FR); Raluca Tiron, Saint-Martin-Le-Vinoux (FR)

(72) Inventors: Christophe Navarro, Bayonne (FR); Stéphane Magnet, Morlanne (FR); Xavier Chevalier, Grenoble (FR); Raluca Tiron, Saint-Martin-Le-Vinoux (FR)

(73) Assignees: Arkema France, Colombes (FR); Institut Polytechnique de Bordeaux, Talence Cedex (FR); Commissariat A L'Energie Atomique et Aux Energies Alternatives, Paris (FR)

(21) Appl. No.: 14/111,897

(22) PCT Filed: Apr. 13, 2012
(86) PCT No.: PCT/FR12/50819

§ 371 Date: Jan. 27, 2014

Related U.S. Application Data
(60) Provisional application No. 61/478,116, filed on Apr. 22, 2011.

(30) Foreign Application Priority Data
Apr. 15, 2011 (FR) 11.53302

(51) Int. Cl. B05D 5/00; C09D 125/14; B05D 5/04; C09D 133/12

(52) U.S. Cl. CPC B05D 5/00; C09D 133/12; C09D 125/14; B05D 5/04
USPC 427/488; 526/329.2; 427/521; 427/385.5; 427/388.2

(57) ABSTRACT

The invention relates to a new surface preparation method using molecules comprising at least one covalent bond which gives rise to free radicals when the molecule is activated thermally, by organic or inorganic redox, photochemically, by plasma, by shear or else under the influence of ionizing radiation.

### CROSS REFERENCE TO RELATED APPLICATIONS

This application is the U.S. National Phase application of PCT International Application No. PCT/EP2012/050819, filed Apr. 4, 2012, and claims priority to French Patent Application No. 11.53302, filed Apr. 15, 2011, and U.S. Provisional Patent Application No. 61/478,116, filed Apr. 22, 2011, the disclosures of which are incorporated by reference in their entirety for all purposes

### FIELD OF THE INVENTION

The invention relates to a new surface preparation method using molecules comprising at least one covalent bond which gives rise to free radicals when the molecule is activated thermally, by organic or inorganic reduction-oxidation, photochemically, by plasma, by shear or else under the influence of ionizing radiation.

The invention also relates to the use of this new preparation method, more particularly in applications for controlling the surface energy of a substrate. For example, it may allow the structuring of a block copolymer which is subsequently applied, but the invention also allows the treatment of surfaces for enhancing the printability of inks or of paint, the wettability, the weathering or ageing resistance, the adhesion, the biocompatibility, the prevention of migration of inks, and the prevention of deposits of proteins, soiling or moulds.

### BACKGROUND OF THE INVENTION

The use, by virtue of their capacity to undergo nanostructuring, of block copolymers in the fields of electronics or optoelectronics is now well known.

It is possible more particularly to structure the arrangement of the blocks constituting the copolymers on scales of smaller than 50 nm.

The desired structuring (for example, generation of domains perpendicular to the surface), however, requires the preparation of the substrate to which the block copolymer is applied, for the purpose of controlling the surface energy. Among the possibilities that are known, a random copolymer is applied to the substrate, it being possible for the monomers of said copolymer to be wholly or partly identical with those used in the block copolymer it is desired to apply.

Moreover, if the wish is to prevent, for example, the diffusion of the random copolymer, it is preferable to graft and/or crosslink the copolymer on the surface, through the use of appropriate functionality. Grafting means the formation of a bond—a covalent bond, for example—between the substrate and the copolymer. Crosslinking means the presence of a plurality of bonds between the copolymer chains.

Among the various possibilities used for orienting the morphology of a block copolymer on a surface, a layer of a random PMMA/PS copolymer is applied beforehand to the surface.

Mansky et al. in Science, Vol. 275, pages 1458-1460 (7 Mar. 1997), showed that a random poly(methyl methacrylate-co-styrene) (PMMA/PS) copolymer functionalized by a hydroxyl function at the chain end allows effective grafting of the copolymer to the surface. The authors attribute the grafting capacity of these copolymers to the presence of the terminal hydroxyl group originating from the initiator; this constitutes a condensation grafting mechanism, which is not very effective from the standpoint of the temperature and times that are required, typically 24 to 48 h at 140° C., in this publication.

At a certain molar fraction of the methyl methacrylate and styrene (MMA and STY) monomers, the interface energies of a random copolymer with PS and PMMA, respectively, are strictly the same (Mansky et al., Macromolecules 1997, 30, 6810-6813). This situation arises in the case of a silicon support having a fine oxide layer on the surface. In this case, this may present a drawback, since the ideal composition of the random copolymer must exhibit exactly this fraction in order for the interface energies with the PS and with the PMMA to be the same. When the composition of the random copolymer changes, the authors showed that a PS-PMMA diblock copolymer applied to the random copolymer may exhibit morphologies which are dependent on the composition of the random copolymer. It is therefore possible to change the morphology of the diblock copolymer in the event of inconsistency of the MMA/STY fraction of the random copolymer.

More recently, certain authors (Han et al., Macromolecules, 2008, 9090-9097, Ji et al., Macromolecules, 2008, 9098-9103, Insik In et al., Langmuir, 2006, 22, 7855-7860) have shown that it is possible, advantageously, to enhance the grafting of the random copolymer on the surface by introducing—no longer at the chain end but within the random copolymer itself—a plurality of functionalities such as hydroxyl or epoxy. In this case, the copolymer is grafted by a plurality of functions on the surface (in the case of hydroxyl) and also crosslinked at the surface (in the case of epoxy).

Patent application US 20090186234 considers the crosslinking of the random copolymer. This approach is also reported in numerous articles, including those of Ryu et al., Macromolecules, 2007, 40, 4296-4300; Bang J. et al., Adv. Mat., 2009, 21, 1-24, or else US 20090179001. With the use of crosslinkable random copolymers, as are widely used in the most recent approaches, a limitation becomes apparent when the desire is to neutralize a surface of given topography. The application of the random copolymer, followed by its crosslinking, completely covers the surface of given topography, which can no longer be exploited for itself, since the crosslinking prevents any removal of a part of the surface which it is not desired should be covered, making this surface, so to speak, non-conforming. When copolymers which are not crosslinked are used, it is possible to remove the random copolymer which is at a distance from the surface, being ungrafted, by the washing of the surface with an appropriate solvent, for example. Therefore, following removal of this excess of copolymer, the initial surface topography is regained, the surface in this case being, so to speak, conforming.

Although the approaches previously described in the literature do allow certain controls over the orientation of a block copolymer on a surface treated with a random copolymer, a limitation is apparent over the extent of the surface in question. This limits the industrial applications for the purpose of obtaining large surface areas of organized block copolymers, allowing in particular the production of materials for electronics at competitive cost.

Furthermore, these approaches require times or temperatures, necessary for the grafting and/or crosslinking of the random copolymers, that are often prohibitive, on an industrial scale.

Moreover, the surfaces treated with the random copolymers must, in the prior art, be prepared beforehand in accordance with specific protocols, and this complicates the application procedures.

The applicant has now found that the functionalized or non-functionalized molecules which carry a covalent bond which is able to give rise to free radicals may advantageously be substituted for the copolymers used in the prior art, whether crosslinkable or not, and have numerous advantages, such as very rapid grafting or crosslinking times, a regularity of dispersion on the surface of the substrate, allowing the subsequent application of block copolymers with a morphology which is controlled and regular over large surface areas, and which avoids the laborious treatments of the substrate before being applied thereto, with effective grafting on numerous surfaces of different chemical origins. The applicant has also observed excellent control over the size of the domains at scales which may be substantially less than 20 nm. Lastly, the molecules, and more particularly the polymers or copolymers, of the invention allow excellent preparation of surfaces having a topography which may subsequently form the site of application of a block copolymer in accordance with a given orientation, while retaining the topography of the initial substrate.

### SUMMARY OF THE INVENTION

The present invention relates to a surface preparation method using molecules comprising at least one covalent bond which gives rise to free radicals when the molecule is activated thermally, by organic or inorganic reduction-oxidation, photochemically, by shear, by plasma, or else under the influence of ionizing radiation, said method comprising the following steps:
contacting the molecules with the surface to be treated,
activating the covalent bond which gives rise to free radicals thermally, by organic or inorganic reduction-oxidation, photochemically, by shear, by plasma, or else under the influence of ionizing radiation, to form a film with a thickness of less than 10 nm and preferably 5 nm on the surface,
evaporating, when present, the solubilisation or dispersion solvent employed for contacting the molecules with the surface to be treated.

### BRIEF DESCRIPTION OF THE DRAWINGS

FIG. 1A is a micrograph showing the morphology observed for the self-assembly of a block copolymer applied to an untreated silicon surface.

FIG. 1B is a micrograph showing the morphology observed for the self-assembly of a block copolymer applied to a treated silicon surface.

FIG. 2A is a micrograph showing the morphology observed for the self-assembly of a block copolymer applied to a clean, untreated polycrystalline gold surface.

FIG. 2B is a micrograph showing the morphology observed for the self-assembly of a block copolymer applied to a cleaned, treated polycrystalline gold surface.

FIG. 2C is a micrograph showing the morphology observed for the self-assembly of a block copolymer applied to an uncleaned, treated polycrystalline gold surface.

FIGS. 3A-3I are micrographs showing the morphology observed for the self-assembly of the block copolymers of Table 1 applied to a treated silicon surface.

FIGS. 4A and 4B are micrographs showing the morphology observed for the self-assembly of block copolymers 11 and 17 of Table 1 applied to a treated silicon surface.

FIGS. 5A and 5B are micrographs showing the morphology observed for the self-assembly of block copolymers 19 and 20 of Table 1 applied to a treated silicon surface.

FIG. 6 is a graph of the grafting kinetics of two copolymers applied to a treated silicon surface.

FIGS. 7A and 7B are graphs of the grafting kinetics of copolymers 3, 8, and 9 of Table 1 applied to a treated silicon surface.

FIGS. 8A and 8B are micrographs showing the morphology observed for the self-assembly of copolymers applied to a treated silicon surface.

FIG. 9 is a graph of the thickness profile of an applied film as a function of the temperature.

### DETAILED DESCRIPTION OF THE INVENTION

By molecules are meant any electrically neutral chemical assembly of at least two atoms connected to one another by a covalent bond. This may be at least one small molecule, at least one macromolecule, or a mixture of molecules and macromolecules.

It is preferably at least one macromolecule, and more particularly at least one oligomer or at least one polymer or mixture thereof. More preferably, the assemblies in question are homopolymers or random, block, gradient or comb copolymers with a molecular mass by weight, measured by size exclusion chromatography (SEC), of more than 500 g per mole.

The homopolymers or copolymers used in the method of the invention may be obtained by any route, including polycondensation, ring-opening polymerization, anionic or cationic polymerization or radical polymerization, the latter being controlled or not. When the copolymers are prepared by radical polymerization or telomerization, this process may be controlled by any known technique, such as NMP (Nitroxide Mediated Polymerization), RAFT (Reversible Addition and Fragmentation Transfer), ATRP (Atom Transfer Radical Polymerization), INIFERTER (Initiator-Transfer-Termination), RITP (Reverse Iodine Transfer Polymerization) or ITP (Iodine Transfer Polymerization).

Preference will be given to those polymerization processes which do not involve metals. The copolymers are prepared preferably by radical polymerization, and more particularly by controlled radical polymerization, even more particularly by nitroxide-controlled polymerization.

The molecules used in the method of the invention correspond to the following general formula:

R1 A R2

A is a covalent bond which gives rise to free radicals, with a bond energy of between 90 and 270 kJ/mol and preferably between 100 and 170 kJ/mol, at 25° C., measured according to the technique described by Kerr, Chem. Rev. 66, 465-500 (1966).

The bond in question is preferably a carbon-oxygen bond of the kind found in alkoxyamines.

More particularly, the alkoxyamines derived from the stable free radical (1) are preferred.

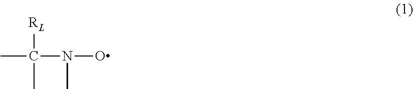

In this formula, the radical R_{L} has a molar mass of more than 15.0342 g/mol. The radical R_{L} may be a halogen atom such as chlorine, bromine or iodine, a saturated or unsaturated, linear, branched or cyclic hydrocarbon group such as an alkyl or phenyl radical, or an ester group —COOR or an alkoxy group —OR, or a phosphonate group —PO(OR)₂, provided that it has a molar mass of more than 15.0342. The radical R_{L}, which is monovalent, is said to be in β position relative to the nitrogen atom of the nitroxide radical. The remaining valencies of the carbon atom and of the nitrogen atom in the formula (1) may be bonded to various radicals such as a hydrogen atom, a hydrocarbon radical such as an alkyl, aryl or arylalkyl radical comprising from 1 to 10 carbon atoms. It is not impossible for the carbon atom and the nitrogen atom in the formula (1) to be joined to one another via a divalent radical, so as to form a ring. Preferably, however, the remaining valencies of the carbon atom and of the nitrogen atom in the formula (1) are bonded to monovalent radicals. The radical R_{L} preferably has a molar mass of more than 30 g/mol. The radical R_{L} may for example have a molar mass of between 40 and 450 g/mol. As an example, the radical R_{L} may be a radical comprising a phosphoryl group, it being possible for said radical R_{L} to be represented by the formula:

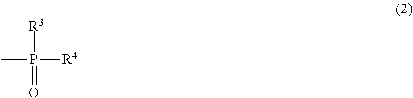

in which R³ and R⁴, which may be identical or different, may be selected from alkyl, cycloalkyl, alkoxy, aryloxy, aryl, aralkyloxy, perfluoroalkyl and aralkyl radicals and may comprise from 1 to 20 carbon atoms. R³ and/or R⁴ may also be a halogen atom such as a chlorine or bromine or fluorine or iodine atom. The radical R_{L} may also comprise at least one aromatic ring, as for the phenyl radical or the naphthyl radical, and the latter radical may be substituted, for example by an alkyl radical comprising from 1 to 4 carbon atoms.

More particularly, the alkoxyamines derived from the following stable radicals are preferred:
N-tert-butyl 1-phenyl-2-methylpropyl nitroxide,
N-tert-butyl 1-(2-naphthyl)-2-methylpropyl nitroxide,
N-tert-butyl 1-diethylphosphono-2,2-dimethylpropyl nitroxide,
N-tert-butyl 1-dibenzylphosphono-2,2-dimethylpropyl nitroxide,
N-phenyl 1-diethylphosphono-2,2-dimethylpropyl nitroxide,
N-phenyl 1-diethylphosphono-1-methylethyl nitroxide,
N-(1-phenyl-2-methylpropyl) 1-diethylphosphono-1-methylethyl nitroxide,
4-oxo-2,2,6,6-tetramethyl-1-piperidinyloxy,
2,4,6-tri-tert-butylphenoxy.

Further to their bond energy, the alkoxyamines used in controlled radical polymerization must allow effective control of the chain sequence of the monomers. Thus, they do not all allow effective control of certain monomers. For example, the alkoxyamines derived from TEMPO do not allow control of more than a limited number of monomers, the same being true for the alkoxyamines derived from 2,2,5-trimethyl-4-phenyl-3-azahexane 3-nitroxide (TIPNO). Conversely, other alkoxyamines derived from nitroxides conforming to the formula (1), especially those derived from nitroxides conforming to the formula (2) and more particularly those derived from N-tert-butyl 1-diethylphosphono-2,2-dimethylpropyl nitroxide, allow controlled radical polymerization to be extended to a large number of monomers.

Moreover, the opening temperature of the alkoxyamines also affects the economic factor. The use of low temperatures will be preferred in order to minimize the industrial difficulties. Preference will therefore be given to the alkoxyamines derived from nitroxides conforming to the formula (1), especially those derived from the nitroxides conforming to the formula (2), and even more particularly those derived from N-tert-butyl 1-diethylphosphono-2,2-dimethylpropyl nitroxide, to those derived from TEMPO or 2,2,5-trimethyl-4-phenyl-3-azahexane 3-nitroxide (TIPNO).

R1 and R2 are at least two atoms which are different or not.

Preferably, R1 and R2 may be small molecules, or macromolecules. When they are macromolecules, R1 and R2 may be an oligomer or a polymer. More preferably, the species in question are, for R1, homopolymers or random or block, gradient or comb copolymers, with a molecular mass, measured by SEC, of more than 500 g/mol, and, for R2, a molecular group with a mass<1000 g/mol.

A gradient copolymer means a copolymer of at least two monomers which is obtained generally by living or pseudo-living polymerization. By virtue of these methods of polymerization, the polymer chains grow simultaneously and therefore at each moment incorporate the same ratios of comonomers. The distribution of the comonomers in the polymer chains therefore depends on the profile, during the synthesis, of the relative concentrations of the comonomers. Reference will be made to the following publications for a theoretical description of gradient copolymers: T. Pakula & al., Macromol. Theory Simul. 5, 987-1006 (1996); A. Aksimetiev & al. J. of Chem. Physics 111, No. 5; M. Janco J. Polym. Sci., Part A: Polym. Chem. (2000), 38(15), 2767-2778; M. Zaremski, & al. Macromolecules (2000), 33(12), 4365-4372; K. Matyjaszewski & al., J. Phys. Org. Chem. (2000), 13(12), 775-786; Gray Polym. Prepr. (Am. Chem. Soc., Div. Polym. Chem.) (2001), 42(2), 337-338; K. Matyjaszewski, Chem. Rev. (Washington, D.C.) (2001), 101(9), 2921-2990.

The monomers which may be used for R1 include the following:

For the precursors of polymers and copolymers by polycondensation: the monomers used for preparing polyamides or copolyamides, polyesters or copolyesters, polyesteramides or copolyesteramides, polyethers, polyimides, polyketones, polyether ketones, alone or in a mixture.

For the precursors of polymers and copolymers by anionic or cationic polymerization or by ring opening: vinyl, vinylaromatic, vinylidene, diene, olefin, allyl or (meth)acrylic monomers, lactones, carbonates, lactams, lactides or glycolides, oxazolines, epoxides, cyclosiloxanes, alone or in a mixture.

For the precursors of polymers and copolymers by radical polymerization:

At least one vinyl, vinylidene, diene, olefin, allyl or (meth)acrylic monomer. This monomer is selected more particularly from vinylaromatic monomers such as styrene or substituted styrenes, especially alpha-methylstyrene, acrylic monomer's such as acrylic acid or its salts, alkyl, cycloalkyl or aryl acrylates such as methyl, ethyl, butyl, ethylhexyl or phenyl acrylate, hydroxyalkyl acrylates such as 2-hydroxyethyl acrylate, etheralkyl acrylates such as 2-methoxyethyl acrylate, alkoxy- or aryloxy-polyalkylene glycol acrylates such as methoxypolyethylene glycol acrylates, ethoxypolyethylene glycol acrylates, methoxypolypropylene glycol acrylates, methoxypolyethylene glycol-polypropylene glycol acrylates, or mixtures thereof, aminoalkyl acrylates such as 2-(dimethylamino)ethyl acrylate (DMAEA), fluorine-containing acrylates, silyl-containing acrylates, phosphorus-containing acrylates such as alkylene glycol phosphate acrylates, glycidyl acrylates, dicyclopentenyloxyethyl acrylates, methacrylic monomers such as methacrylic acid or its salts, alkyl, cycloalkyl, alkenyl or aryl methacrylates such as methyl methacrylate (MMA), or lauryl, cyclohexyl, allyl, phenyl or naphthyl methacrylate, hydroxyalkyl methacrylates such as 2-hydroxyethyl methacrylate or 2-hydroxypropyl methacrylate, etheralkyl methacrylates such as 2-ethoxyethyl methacrylate, alkoxy- or aryloxy-polyalkylene glycol methacrylates such as methoxypolyethylene glycol methacrylates, ethoxypolyethylene glycol methacrylates, methoxypolypropylene glycol methacrylates, methoxypolyethylene glycol-polypropylene glycol methacrylates or mixtures thereof, aminoalkyl methacrylates such as 2-(dimethylamino)ethyl methacrylate (DMAEMA), fluorine-containing methacrylates such as 2,2,2-trifluoroethyl methacrylate, silyl-containing methacrylates such as 3-methacryloylpropyltrimethylsilane, phosphorus-containing methacrylates such as alkylene glycol phosphate methacrylates, hydroxyethylimidazolidone methacrylate, hydroxyethylimidazolidinone methacrylate, 2-(2-oxo-1-imidazolidinyl)ethyl methacrylate, acrylonitrile, acrylamide or substituted acrylamides, 4-acryloyl-morpholine, N-methylolacrylamide, methacrylamide or substituted methacrylamides, N-methylolmethacrylamide, methacrylamidopropyltrimethylammonium chloride (MAPTAC), glycidyl methacrylates, dicyclopentenyloxyethyl methacrylates, itaconic acid, maleic acid or its salts, maleic anhydride, alkyl or alkoxy- or aryloxypolyalkylene glycol maleates or hemimaleates, vinylpyridine, vinylpyrrolidinone, (alkoxy)poly(alkylene glycol) vinyl ethers or divinyl ethers, such as methoxypoly(ethylene glycol) vinyl ether, poly(ethylene glycol) divinyl ether, olefinic monomers, including ethylene, butene, hexene and 1-octene, diene monomers, including butadiene, isoprene, and also fluorine-containing olefinic monomers, and vinylidene monomers, including vinylidene fluoride, alone or in a mixture of at least two aforementioned monomers.

R1 is preferably a polymer, copolymer, oligomer or cooligomer radical and R2 is preferably a nitroxy group. With preference, R2 is N-tert-butyl 1-diethylphosphono-2,2-dimethylpropyl nitroxide.

R1 is preferably a random copolymer with a molecular mass as measured by SEC using polystyrene standards of between 500 g and 200 000 g/mol, more preferably between 1000 and 20 000 g/mol, and even more preferably between 5000 and 10 000 g/mol, to give an application of copolymer by the method of the invention of less than 10 nm and more particularly less than 5 nm. The dispersity of R1, the ratio of the weight-average molecular masses to the number-average molecular masses, is less than 5, more particularly less than 2, and preferably less than 1.5. R1 preferably consists of monomers among which mention may be made of styrene, methyl methacrylate, glycidyl methacrylate (GMA), 2-hydroxyethyl methacrylate (HEMA), methyl acrylate or ethyl acrylate. Styrene is present preferably in the copolymer in molar amounts of from 40% to 100% and more preferably from 60% to 85%.

According to one preferred embodiment of the invention, the random copolymer of the invention is prepared with 2-methyl-2-[N-tert-butyl-N-(diethoxyphosphoryl-2,2-dimethylpropyl)aminoxy]propionic acid (Blocbuilder MA®-Arkema), styrene and methyl methacrylate.

The surface preparation method using the molecules of the invention is applicable to any surface and does not necessitate particular preparation, as is often the case when the desire is to prepare a surface in order to apply to it a random copolymer for the purpose of a subsequent application of block copolymer exhibiting a regular morphology over a large surface area, without defects.

The surface is preferably mineral and more preferably is of silicon. Even more preferably, the surface is of silicon having a native oxide layer.

According to one preferred embodiment of the invention, the block copolymers applied to the surfaces treated by the method of the invention are preferably diblock copolymers.

The method of the invention involves applying preferably the molecule dissolved beforehand in an appropriate solvent, by techniques which are known to the skilled person, such as, for example, the technique known as spin coating, doctor blade, knife system or slot die system, although any other technique may be used, such as dry application, in other words application without involving dissolution beforehand.

The method of the invention is aimed at forming a molecular layer of typically less than 10 nm and preferably less than 5 nm. When the method of the invention is used for preparing surfaces for the purpose of applying block copolymer, the molecule will preferably be a random copolymer and the interaction energies with the two blocks of the block copolymer or copolymers subsequently applied will be equivalent.

The method of the invention may be used in applications necessitating control of surface energy, such as the application of block copolymers having a given nanostructuring, the enhancement of the printability of inks or of paint, of wettability, of weathering or ageing resistance, of adhesion, of biocompatibility, of prevention of migration of inks, or of prevention of the deposition of proteins, of soiling or moulds.

### Example 1

### Preparation of a Hydroxy-Functionalized Alkoxyamine (Initiator 2) from the Commercial Alkoxyamine BlocBuilder® MA (Initiator 1)

A 1 l round-bottomed flask purged with nitrogen is charged with:
226.17 g of BlocBuilder® MA (initiator 1) (1 equivalent)
68.9 g of 2-hydroxyethyl acrylate (1 equivalent)
548 g of isopropanol.

The reaction mixture is heated at reflux (80° C.) for 4 hours and then the isopropanol is evaporated under vacuum. This gives 297 g of hydroxy-functionalized alkoxyamine (initiator 2) in the form of a highly viscous yellow oil.

### Example 2

Experimental protocol for preparing copolymers from initiators 1, 2, 3 or 4.
Initiator 1 is the commercial alkoxyamine BlocBuilder® MA.
Initiator 2 is the alkoxyamine prepared according to Example 1.
Initiator 3 consists of a pair of reagents: azoisobutyronitrile (AIBN) (1 molar equivalent) and N-tert-butyl 1-diethylphosphono-2,2-dimethylpropyl nitroxide (2 molar equivalents).
Initiator 4 is azoisobutyronitrile (AIBN).

### Preparation of polystyrene/polymethyl methacrylate, polystyrene/polymethyl methacrylate/poly-2-hydroxyethyl methacrylate or polystyrene/polymethyl methacrylate/polyglycidyl methacrylate copolymers

A stainless steel reactor equipped with a mechanical stirrer and a jacket is charged with toluene, and also with the monomers such as styrene (S), methyl methacrylate (MMA), 2-hydroxyethyl methacrylate (HEMA), glycidyl methacrylate (GMA), and the initiator. The mass ratios between the different styrene (S), methyl methacrylate (MMA), 2-hydroxyethyl methacrylate (HEMA) and glycidyl methacrylate (GMA) monomers are described in Table 1. The mass charge of toluene is fixed at 30% relative to the reaction mixture. The reaction mixture is stirred and degassed by sparging of nitrogen at ambient temperature for 30 minutes.

The temperature of the reaction mixture is then raised to 115° C. (in the case of the polymerizations carried out in the presence of initiators 1, 2 and 3) or 75° C. (in the case of the polymerizations carried out in the presence of initiator 4). The time t=0 begins at ambient temperature. The temperature is held at 115° C. or 75° C. throughout the polymerization, until a monomer conversion of the order of 70% is attained. Samples are taken at regular intervals in order to determine the kinetics of polymerization by gravimetry (measurement of dry extract).

When the conversion of 70% is attained, the reaction mixture is cooled to 60° C. and the solvent and residual monomers are evaporated under vacuum. Following evaporation, methyl ethyl ketone is added to the reaction mixture in an amount such as to produce a copolymer solution of the order of 25% by mass.

This copolymer solution is then introduced dropwise into a beaker containing a non-solvent (heptane), in order to precipitate the copolymer. The mass ratio between solvent and non-solvent (methyl ethyl ketone/heptane) is of the order of 1/10. The precipitated copolymer is recovered in the form of a white powder after filtration and drying.

TABLE 1

| | Initial reaction state | | | | | | | | |
|---|---|---|---|---|---|---|---|---|---|
| | Initial composition | | Ratio by mass of | | | | | | |
| | by mass of the | Nature of | initiator relative | | | | | | |
| | monomers | initiator | to the monomers | Characteristics of the copolymer | | | | | |
| Copolymers | S/MMA/HEMA/GMA | used | S, MMA, HEMA and GMA | % PS ^{(a)} | Mp ^{(a)} | Mn ^{(a)} | Mw ^{(a)} | Ip ^{(a)} | |
| 1 | 42/58/0/0 | initiator 2 | 0.03 | 48% | 18 760 | 12 980 | 18 940 | 1.5 | inventive |
| 2 | 50/50/0/0 | initiator 2 | 0.04 | 69% | 18 930 | 12 410 | 20 360 | 1.6 | inventive |
| 3 | 58/42/0/0 | initiator 2 | 0.03 | 64% | 16 440 | 11 870 | 16 670 | 1.4 | inventive |
| 4 | 66/34/0/0 | initiator 2 | 0.03 | 65% | 15 480 | 11 930 | 15 900 | 1.3 | inventive |
| 5 | 74/26/0/0 | initiator 2 | 0.03 | 70% | 15 210 | 12 060 | 15 760 | 1.3 | inventive |
| 6 | 58/34/4/0 | initiator 2 | 0.03 | 57% | 17 730 | 12 870 | 18 210 | 1.4 | inventive |
| 8 | 58/42/0/0 | initiator 2 | 0.02 | 60% | 49 020 | 23 150 | 46 280 | 2.0 | inventive |
| 9 | 58/42/0/0 | initiator 2 | 0.01 | 59% | 90 010 | 36 350 | 80 270 | 2.2 | inventive |
| 10 | 58/38/4/0 | initiator 1 | 0.03 | 58% | 14 530 | 10 410 | 14 560 | 1.4 | inventive |
| 11 | 74/26/0/0 | initiator 1 | 0.03 | 73% | 15 040 | 12 280 | 15 400 | 1.2 | inventive |
| 12 | 85/15/0/0 | initiator 2 | 0.03 | 84% | 16 170 | 13 660 | 17 310 | 1.3 | inventive |
| 14 | 74/23.5/0/2.5 | initiator 2 | 0.03 | 73% | 17 690 | 14 620 | 26 490 | 1.8 | inventive |
| 16 | 74/26/0/0 | initiator 2 | 0.07 | 73% | 8 380 | 7 120 | 8 960 | 1.3 | inventiive |
| 17 | 74/26/0/0 | initiator 3 | 0.03 | 72% | 17 260 | 12 700 | 17 400 | 1.4 | inventive |
| 18 | 100/0/0/0 | initiator 2 | 0.07 | 100% | 7 440 | 6 710 | 8 080 | 1.2 | inventive |
| 19 | 49/51/0/0 | initiator 4 | 0.02 | 46% | 39 500 | 23 000 | 40 000 | 1.7 | non-inventive |
| 20 | 74/26/0/0 | initiator 4 | 0.02 | 64% | 39 000 | 25 000 | 39 600 | 1.6 | non inventive |

^{(a)} Determined by size exclusion chromatography. The polymers are dissolved at 1 g/l in THF stabilized with BHT. Calibration is carried out using monodisperse polystyrene standards. Double detection by refractive index and UV at 254 nm makes it possible to determine the percentage of polystyrene in the copolymer.

### Example 3

Apart from the copolymers described in Example 2, the block copolymer PS-b-PMMA (PS 46.1 kg·mol⁻¹, PMMA 21 kg·mol⁻¹, PDI=1.09) was purchased from Polymer Source Inc. (Dorval, Quebec) and used without subsequent purification.

### Grafting on SiO₂:

Silicon plates (crystallographic orientation {100}) are cut by hand into pieces measuring 3×4 cm and are cleaned by piranha treatment (H₂SO₄/H₂O₂ 2:1 (v:v)) for 15 minutes, then rinsed with deionized water and dried in a stream of nitrogen just before functionalization. The remainder of the procedure is as described by Mansky & al. (Science, 1997, 1458), with a single modification (baking takes place in ambient atmosphere and not under vacuum). The random copolymers are dissolved in toluene to give solutions at 1.5% by mass. A solution of PS-r-PMMA is dispensed by hand on to a freshly cleaned wafer, then spread by spin coating at 700 rpm, to give a film with a thickness of approximately 90 nm. The substrate is then simply placed on a hotplate, brought beforehand to the desired temperature, under ambient atmosphere for a variable time. The substrate is then washed by sonication in a number of toluene baths for a few minutes in order to remove the ungrafted polymer from the surface, and then is dried under a stream of nitrogen.

### Grafting on Gold:

The gold substrates used consist of polycrystalline gold and are manufactured as follows: a thermal silica layer is first applied to an Si surface (100 nm), and then a tie layer of chromium (˜10 nm) is evaporated on to the surface, and finally a layer of ˜500 nm of gold is evaporated on to the substrate.

The gold surfaces are cleaned with an oxygen plasma for 5 minutes, and then the gold oxides formed are reduced by a bath in absolute ethanol for 20 minutes, and the surface is dried under a stream of nitrogen (H. Ron & al., Langmuir, 1998, 1116). If the use of plasma is not desired, the gold surfaces may simply be washed by sonication in a bath of absolute ethanol and then a bath of toluene for 10 minutes, and then dried under a stream of nitrogen.

The procedure followed for grafting the polymers on to gold is the same as that for the silica surfaces.

### Characterizations:

The XPS measurements were carried out on a personalized 220 I spectrometer from VG Scientific; the spectra were obtained with an X-ray source calibrated to the Kα ray of aluminium (1486.6 eV). The film thickness measurements were performed on a Prometrix UV1280 ellipsometer. The images obtained by scanning electron microscopy were recorded on a CD-SEM H9300 from Hitachi.

### Example 4

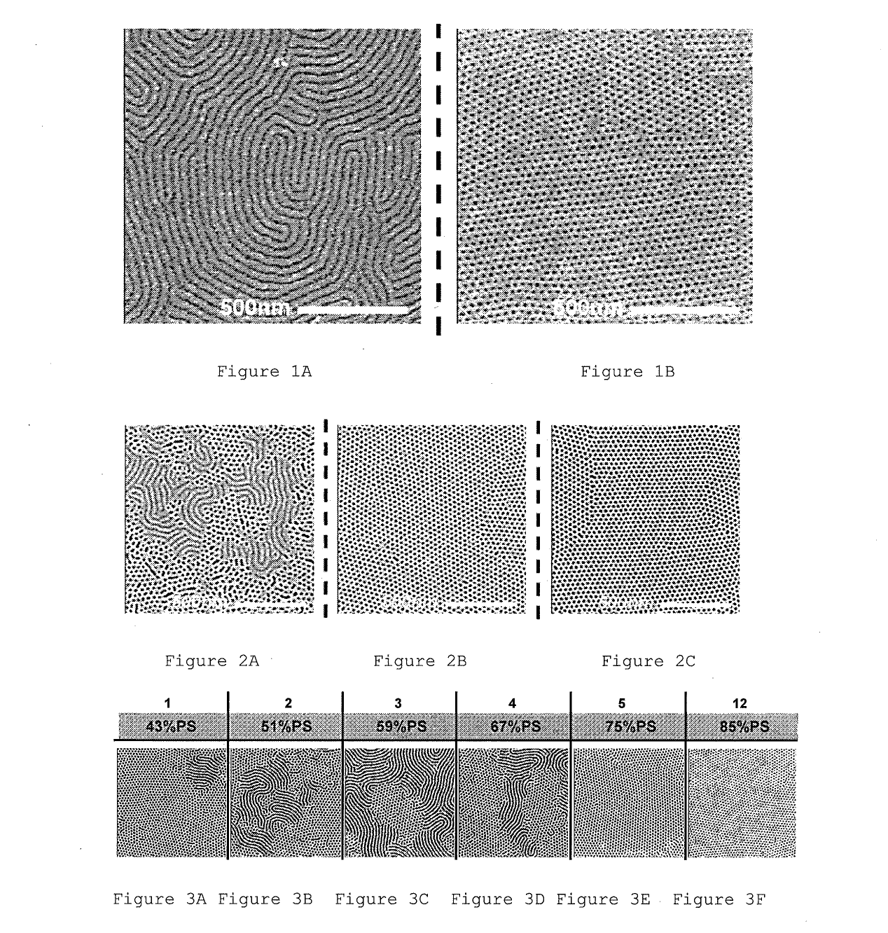

In this example, a comparison is made of the morphology observed for the self-assembly of the cylindrical block copolymer (PS-b-PMMA) of Example 3 when it is applied to an untreated silicon surface (FIG. 1A), resulting in a parallel orientation of the block copolymer relative to the surface, or to a surface treated according to the method of the invention, using the random copolymer 5 of Table 1, and leading to a perpendicular orientation of the block copolymer relative to the surface (FIG. 1E).

### Example 5

In this example, a comparison is made of the morphology observed for the self-assembly of the cylindrical block copolymer (PS-b-PMMA) of Example 3 when it is applied to a cleaned polycrystalline gold surface but in the absence of copolymer of the invention (FIG. 2A), resulting in a parallel and perpendicular orientation of the block copolymer relative to the surface, to a cleaned polycrystalline gold surface treated according to the method of the invention, using the random copolymer 5 of Table 1, and resulting in a perpendicular orientation of the block copolymer relative to the surface (FIG. 2B), or to an uncleaned polycrystalline gold surface treated according to the method of the invention, using the random copolymer 5 of Table 1, and resulting in a perpendicular orientation of the block copolymer relative to the surface (FIG. 2C).

### Example 6

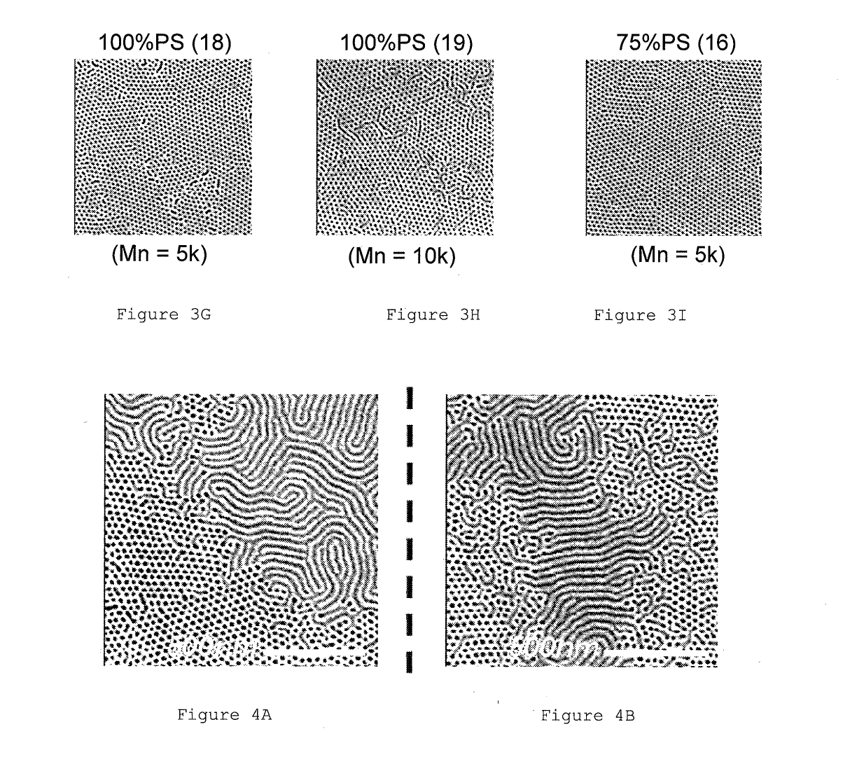

In this example, a comparison is made of the morphology observed for the self-assembly of the cylindrical block copolymer (PS-b-PMMA) of Example 3 when it is applied to a silicon surface treated according to the method of the invention, using the random copolymers 1, 2, 3, 4, 5, 12, 16, 18 and 19 of Table 1 (FIGS. 3A, 3B, 3C, 3D, 3E, 3F, 3G, 3H, 3I), for which the composition varies in terms of styrene. It will be noted that a maximum of perpendicular orientation of the block copolymer is situated when the composition of the random copolymer in terms of styrene is in the range of 75-85%.

### Example 7

In this example, a comparison is made of the morphology observed for the self-assembly of the cylindrical block copolymer (PS-b-PMMA) of Example 3 when it is applied to a silicon surface treated according to the method of the invention, using the random copolymers 11 and 17 of Table 1. It will be noted in particular therein that the presence of acid and alkoxyamine function in the copolymer 11 of Table 1 or the absence of any function other than the alkoxyamine of copolymer 17 in Table 1 leads to the same result (FIGS. 4A and 4B).

### Example 8

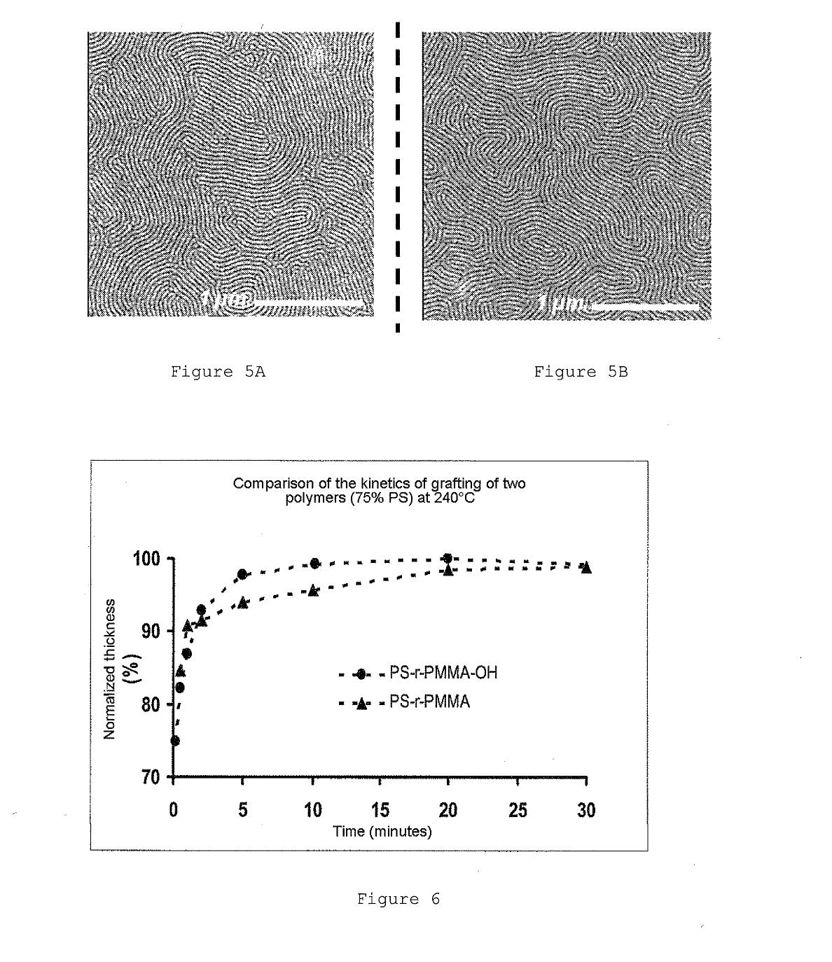

In this example, an observation is made of the morphology observed for the self-assembly of the cylindrical block copolymer (PS-b-PMMA) of Example 3 of the invention when it is applied to a silicon surface treated with the random copolymer 19 of Table 1 (FIG. 5A) or 20 (FIG. 5B), resulting in a parallel orientation of the block copolymer.

### Example 9

In this example, a comparison is made of the grafting kinetics of copolymers 5 and 11 of Table 1, applied to a silicon surface treated according to the method of the invention (FIG. 6, thicknesses normalized). By normalized thickness, it is considered that the maximum thickness attained by each polymer is 100%.

It will be noted that, in spite of the absence of hydroxyl function in the copolymer 11 (PS-r-PMMA), the same grafting kinetics are observed as for the copolymer 5 (PS-PMMA-OH).

### Example 10

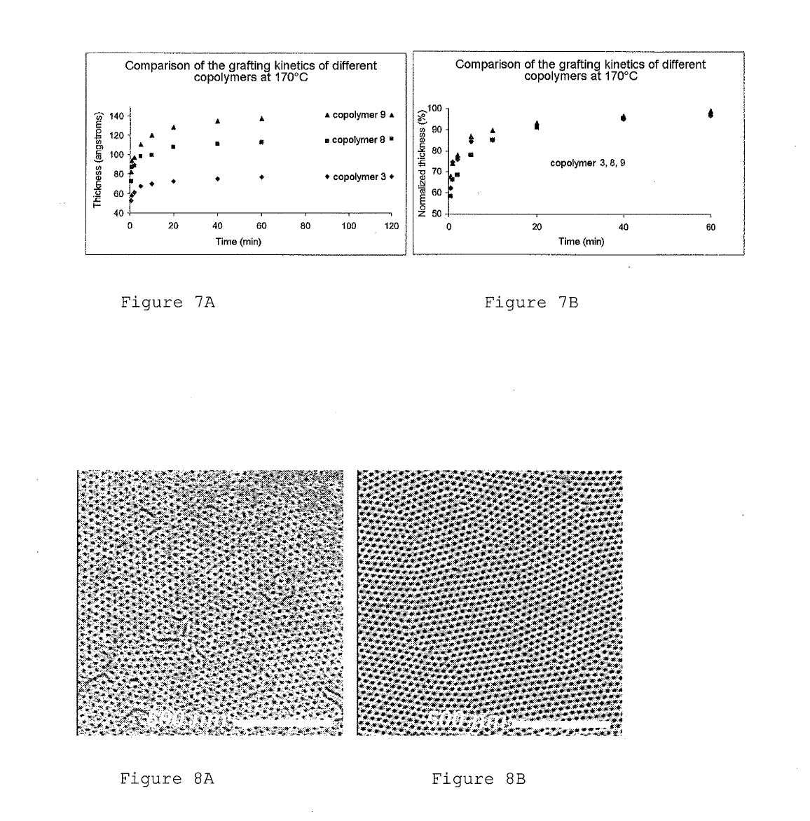

In this example, a comparison is made of the grafting kinetics of copolymers 3, 8 and 9 of Table 1, applied to a silicon surface treated according to the method of the invention. It will be noted that there is little influence of the molecular mass on the grafting kinetics (FIGS. 7A and 7B).

### Example 11

In this example, an observation is made of the morphology observed for the self-assembly of the cylindrical block copolymer (PS-b-PMMA) when it is applied to a silicon surface treated with Example 6 of Table 1 (FIG. 8A) and Example 14 of Table 1 (FIG. 8B), resulting in a perpendicular orientation of the block copolymer.

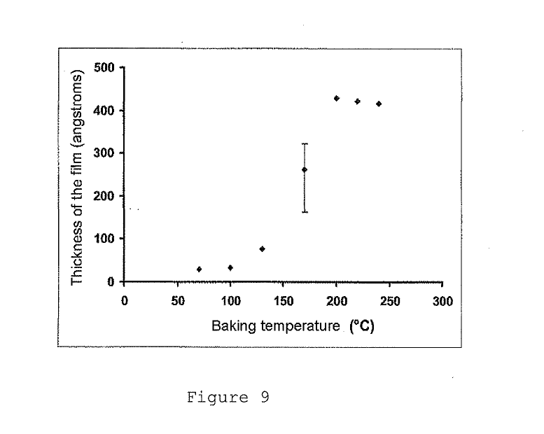

FIG. 9 shows the thickness profile of the applied film of copolymer 14 as a function of the temperature.

1. Surface preparation method using molecules comprising at least one covalent bond which gives rise to free radicals when the molecule is activated thermally, by organic or inorganic reduction-oxidation, photochemically, by shear, by plasma, or else under the influence of ionizing radiation, said method comprising the following steps:
contacting the molecules with the surface to be treated,
activating the covalent bond which gives rise to free radicals thermally, by organic or inorganic reduction-oxidation, photochemically, by shear, by plasma, or else under the influence of ionizing radiation, to form a film with a thickness of less than 10 nm on the surface,
evaporating, when present, the solubilisation or dispersion solvent employed for contacting the molecules with the surface to be treated.

2. Method according to claim 1, wherein the covalent bonds which give rise to free radicals have a bond energy of between 90 and 270 kJ/mol.

3. Method according to claim 1, wherein the covalent bonds which give rise to free radicals have a bond energy of between 100 and 170 kJ/mol.

4. Method according to claim 1, wherein the molecule is a polymer.

5. Method according to claim 1, wherein the molecule is a copolymer.

6. Method according to claim 5, wherein the copolymer is a random copolymer.

7. Method according to claim 5, wherein the copolymer is a gradient copolymer.

8. Method according to claim 6, wherein the copolymer has a molecular mass of more than 500 g/mol.

9. Method according to claim 6, wherein the copolymer has a molecular mass of between 1000 and 20 000 g/mol.

10. Method according to claim 6, wherein the copolymer is prepared by controlled radical polymerization.

11. Method according to claim 6, wherein the copolymer is prepared by nitroxide-controlled radical polymerization.

12. Method according to claim 11, wherein the nitroxides conform to the formula below: 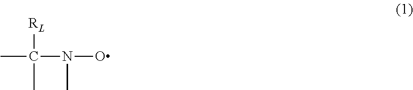
in which the radical RL has a molar mass of more than 15,0342.

13. Method according to claim 12, wherein the nitroxides is selected from:
N-tert-butyl 1-phenyl-2-methylpropyl nitroxide,
N-tert-butyl 1-(2-naphthyl)-2-methylpropyl nitroxide,
N-tert-butyl 1-diethylphosphono-2,2-dimethylpropyl nitroxide,
N-tert-butyl 1-dibenzylphosphono-2,2-dimethylpropyl nitroxide,
N-phenyl 1-diethylphosphono-2,2-dimethylpropyl nitroxide,
N-phenyl 1-diethylphosphono-1-methylethyl nitroxide,
N-(1-phenyl-2-methylpropyl) 1-diethylphosphono-1-methylethyl nitroxide,
4-oxo-2,2,6,6-tetramethyl-1-piperidinyloxy, and
2,4,6-tri-tert-butylphenoxy.

14. Method according to claim 13, wherein the nitroxide is N-tert-butyl 1-diethylphosphono-2,2-dimethylpropyl nitroxide.

15. Copolymer for implementing the method according to claim 1, characterized by the product of synthesis of methyl methacrylate, of styrene and of 2-methyl-2-[N-tert-butyl-N-(diethoxyphosphoryl-2,2dimethylpropyl)aminoxy]propionic acid.

16. Method according to claim 1, wherein the surface is mineral.

17. Method according to claim 1, wherein the surface is metallic.

18. Method according to claim 16, wherein the surface is of silicon.

19. Method according to claim 17, wherein the surface is gold.

20. Method for controlling the surface energy of a substrate for controlling the structuring of block copolymers, enhancing the printability of inks or paint, the wettability, the weathering or ageing resistance, the adhesion, the biocompatibility, the prevention of migration of inks, the prevention of deposits of proteins, of soiling or of moulds, using molecules comprising at least one covalent bond which gives rise to free radicals when the molecule is activated thermally, by organic or inorganic reduction-oxidation, photochemically, by shear, by plasma, or else under the influence of ionizing radiation, said method comprising the following steps:
contacting the molecules with the substrate to be treated,
activating the covalent bond which gives rise to free radicals thermally, by organic or inorganic reduction-oxidation, photochemically, by shear, by plasma, or else under the influence of ionizing radiation, to form a film with a thickness of less than 10 nm on the substrate,
evaporating, when present, the solubilisation or dispersion solvent employed for contacting the molecules with the substrate to be treated.
